(19) United States
(12) Patent Application Publication
(10) Pub. No.: US 2015/0099405 A1
(43) Pub. Date: Apr. 9, 2015

(54) Mechanical Lug

(71) Applicant: Trystar, Inc., Faribault, MN (US)

(72) Inventors: Frederick Alan Dahl, Dundas, MN (US); James Jerome Koberg, Morristown, MN (US); Brian Allen Amacher, Faribault, MN (US)

(21) Appl. No.: 14/046,307

(22) Filed: Oct. 4, 2013

(51) Int. Cl. H01R 4/36; H01R 13/03

(52) U.S. Cl. CPC H01R 4/36; H01R 13/03
USPC 439/814

(57) ABSTRACT

This disclosure provides systems and methods for connecting electrical cables to electrical devices via mechanical lugs. Illustrative mechanical lug can include a body portion, a connection point, an electrical cable fastener, a shoulder portion, a neck portion, and an electrical device fastener. The connection point may include grooves, which can be adapted to increase the surface area of contact between the electrical cable and the mechanical lug and/or to grip the electrical cable to inhibit inadvertent disconnection. The mechanical lug may include turn prevents to inhibit rotation of the mechanical lug. Embodiments of the invention may include a method for connecting an electrical cable to an electrical device.

### TECHNICAL FIELD

This disclosure generally relates to technology for connecting an electrical cable to an electrical device.

### BACKGROUND

Electrical cable lugs are often used to connect an electrical cable to an electrical device. Examples of electrical devices include an electrical panel, bus bar, a junction box, and so on. Lugs are typically made from electrically conductive materials (e.g., copper). The electrical cable can be connected to the electrical device via one or more connection points in the lug. An insulated casing of the cable is removed and the exposed electrical cable is fastened to the connection point(s) in the lug (e.g., using mechanical fasteners such as a bolt assembly). The lug is then fastened to the electrical device (e.g., using mechanical fasteners).

Safety and durability of the electrical connection between the electrical cable and the electrical device often depend on various properties of the lug. It is often the case that material with high electrical conductivity does not have sufficient mechanical strength for a durable electrical connection. Repetitive thermal fatigue can lead to poor electrical contact and result in the exposed electrical cable losing mechanical connection with the connection point. Poor electrical contact and lack of sufficient mechanical strength of the lug can lead to lack of compliance with electrical safety standards and create safety hazards due to exposed electrical cables. On the other hand, many materials with sufficient strength and durability are not suitable for serving as a mechanical lug because they lack sufficient electrical conductivity.

### SUMMARY

Examples described in this disclosure provide a mechanical lug with physical and material features that enhance the mechanical and electrical connection between an electrical cable and an electrical device. In one aspect, this disclosure teaches a mechanical lug for electrically connecting an electrical cable and an electrical device. In some examples, the mechanical lug can include a body portion, a connection point, an electrical cable fastener, a shoulder portion, a neck portion, and an electrical device fastener. The body portion can have a longitudinal axis. The connection point can be defined in the body portion transversely to the longitudinal axis. In many examples, the connection point can include grooves. The electrical cable fastener can be configured to press the electrical cable into contact with the grooves when the electrical cable is inserted into the connection point. The shoulder portion can be coupled to the body portion. The shoulder portion can have a shoulder surface that is oriented transversely to the longitudinal axis. The shoulder surface can be configured to contact a first surface of the electrical device. The neck portion can be coupled to the shoulder portion. The neck portion can be configured to extend through a hole in the electrical device. The electrical device fastener can be configured to fasten the mechanical lug to the electrical device.

In one aspect, a method can connect a cable to an electrical device via a mechanical lug such as those discussed herein. The method can include inserting an uncovered portion of an electrical cable into the mechanical lug's connection point. The method can include pressing that uncovered portion into contact with the connection point's grooves by the mechanical lug's electrical cable fastener. The method can include extending the mechanical lug's neck portion through a hole in an electrical device. The method can include bringing the mechanical lug's shoulder portion into contact with a first surface of the electrical device. The method can include fastening the mechanical lug to the electrical device with the mechanical lug's electrical device fastener.

Certain mechanical lugs in accordance with embodiments of the present invention may have one or more advantages. For example, mechanical lug like those described herein can improve the safety of electrical connections and can make it easier to comply with electrical safety standards. Embodiments of the mechanical lug with grooves at the connection point can improve electrical conduction and result in greater heat dissipation at the connection point. Many such embodiments can enhance the integrity of the mechanical connection between the electrical cable and the lug, thereby significantly reducing the likelihood of the electrical cable being disconnected due to repetitive thermal fatigue at the connection point. Embodiments of the mechanical lug can provide improved material hardness and tensile strength, thereby providing a rugged, safe and durable electrical connection. Some mechanical lug embodiments discussed in this disclosure provide greater electrical conductivity between the mechanical lug and the electrical device. For example, some embodiments provide significantly more surface contact between the lug and the electrical device than conventional lug/component configurations.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a perspective view of an illustrative mechanical lug according to some embodiments of the invention.

FIG. 2A is a front view of the mechanical lug of FIG. 1.

FIG. 2B is a top view of the mechanical lug of FIG. 1.

FIG. 2C is a side view of the mechanical lug of FIG. 1.

FIG. 3A is front view of illustrative mechanical lugs operably coupled to an electrical device according to some embodiments of the invention.

FIG. 3B is a side view of the mechanical lug of FIG. 3A.

FIG. 4A is a perspective view of an illustrative mechanical lug according to some embodiments of the invention.

FIG. 4B is a side view of the mechanical lug of FIG. 4A.

FIG. 4C is a front view of the mechanical lug of FIG. 4A.

FIG. 5A is a front view of an illustrative mechanical lug according to some embodiments of the invention, with hidden features shown with dashed lines.

FIG. 5B is a bottom view of the mechanical lug of FIG. 5A.

FIG. 6A is a top view of an illustrative mechanical lug according to some embodiments of the invention, with hidden features shown as dashed lines.

FIG. 6B is a cross-sectional view of the mechanical lug of FIG. 6A taken along the line A-A.

### DETAILED DESCRIPTION

The following detailed description is exemplary in nature and is not intended to limit the scope, applicability, or configuration of the invention in any way. Rather, the following description provides some practical illustrations for implementing examples of the present invention. Examples of constructions, materials, dimensions, and manufacturing processes are provided for selected elements, and all other elements employ that which is known to those of ordinary skill in the field of the invention. Those skilled in the art will recognize that many of the noted examples have a variety of suitable alternatives.

Embodiments of the invention include a mechanical lug 100 for electrically connecting an electrical cable and an electrical device. The electrical cable can include many conducting filaments of an electrically conductive material (e.g., copper, aluminum) housed in an insulating sheath. The electrical cable can include finely stranded wire, types B, C, and K wire, and the like. Often, the insulating sheath of the electrical cable can be stripped to expose the conducting filaments so that the exposed electrical cable can be electrically connected to the mechanical lug 100. The electrical cable can be rated to a high current rating (e.g., 125 amperes, 150 amperes, 400 amperes, etc.) suitable for use in power generation equipment. Electrical cables of various sizes can be accommodated by the mechanical lug 100. The electrical device 200 can be a bus bar, an electrical power distribution panel, a transformer and similar electrical components. Such electrical devices can be found in domestic and industrial electrical panels, enclosures, or devices.

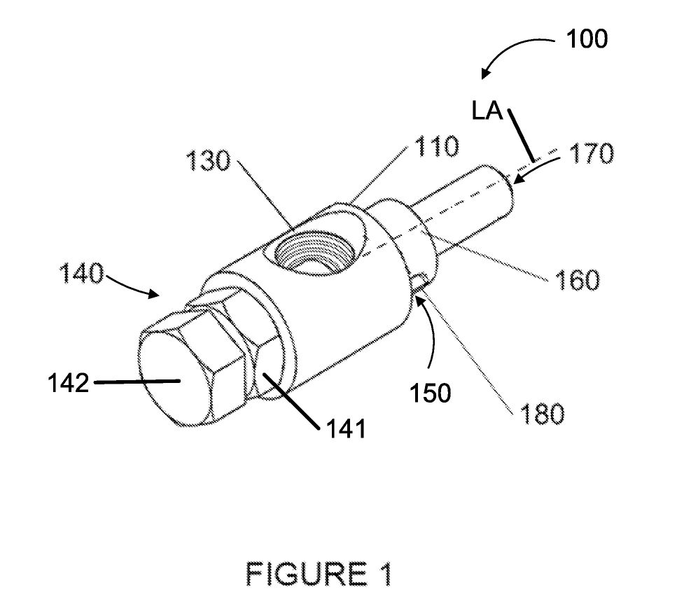

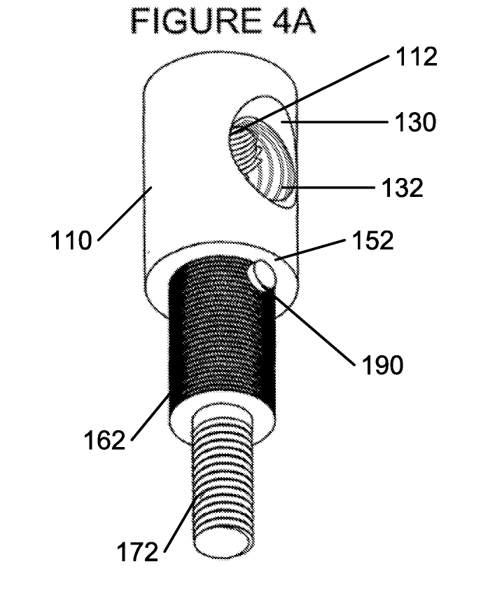

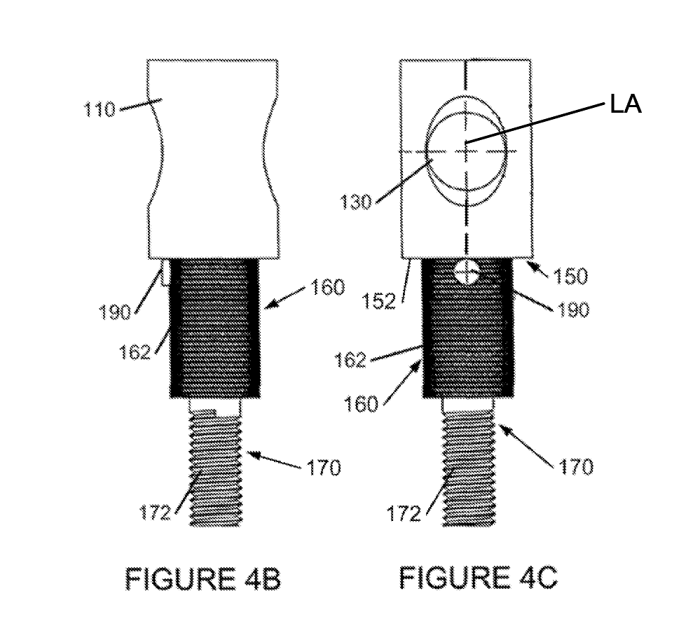

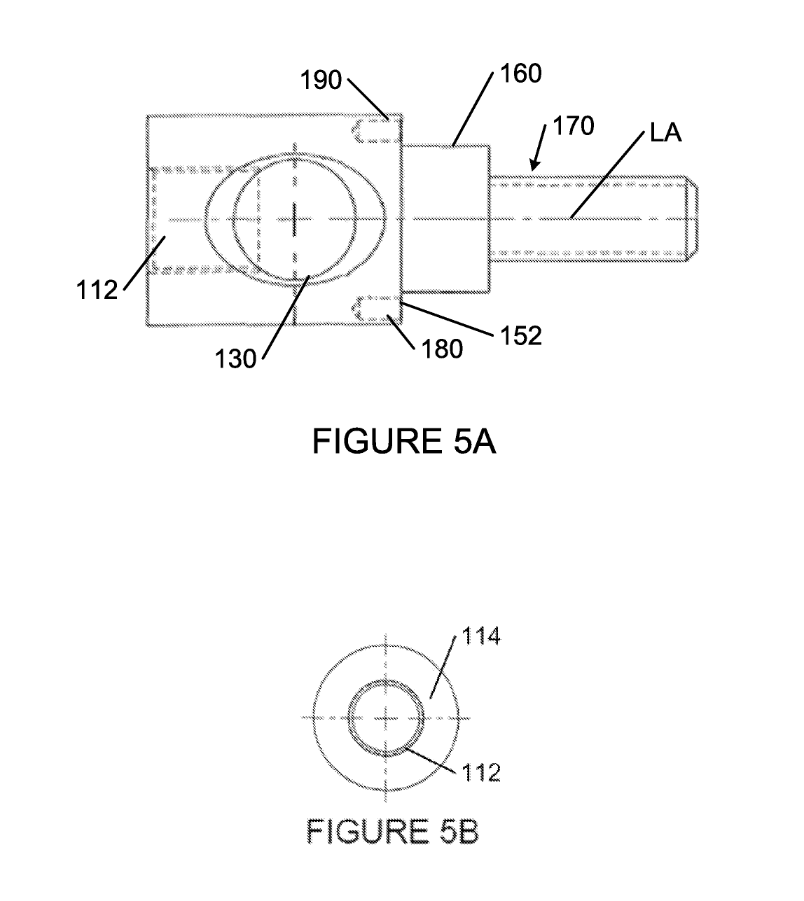

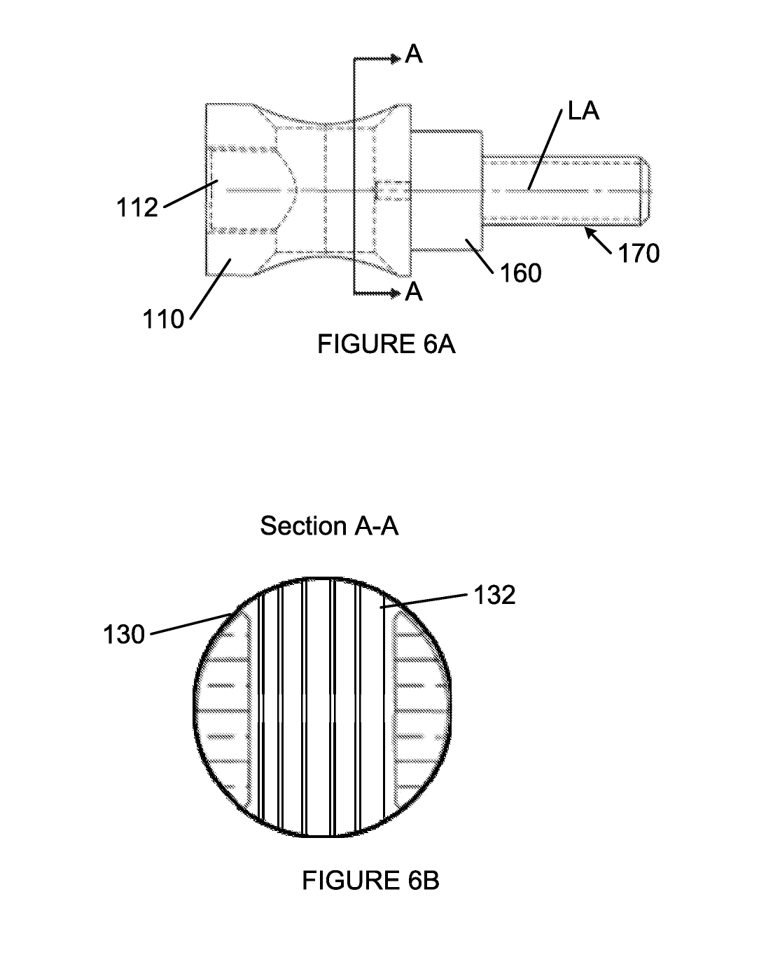

Reference is now made to FIGS. 1-3B. The mechanical lug 100 can include a body portion 110, a connection point 130, an electrical cable fastener 140, a shoulder portion 150, a neck portion 160 and an electrical device fastener 170. The mechanical lug 100 can be fabricated using techniques such as casting or one or more metalworking techniques (e.g., turning, thread cutting, metal forming, undercutting, etc.). The mechanical lug 100 can be formed from a bar or rod of a material with suitable mechanical properties, such as electrical conductivity approximately equal to that of highly conductive metals (e.g., copper, aluminum) and high material hardness and tensile strength (e.g. alloys including chromium, vanadium, zirconium, and the like). The body portion 110 can have a longitudinal axis LA. The body portion 110 is illustrated as generally cylindrical in shape. Other shapes (e.g., cuboidal, cubical) can be accommodated without loss of functionality. The body portion 110 can include an opening 112 at a first surface 114 adapted to receive the electrical cable fastener 140. The first surface 114 can be a planar surface disposed perpendicular to the longitudinal axis LA of the body portion 110. In the illustrated embodiment best seen in FIGS. 4A, 5A-5D, the opening (112 of FIGS. 4A, 5A, 6A) on the first surface 114 of the body portion 110 includes internal threads adapted to engage a threaded portion of the electrical cable fastener 140. The internal threads can be right handed or left handed threads, adapted to engage with right handed or left handed external threads.

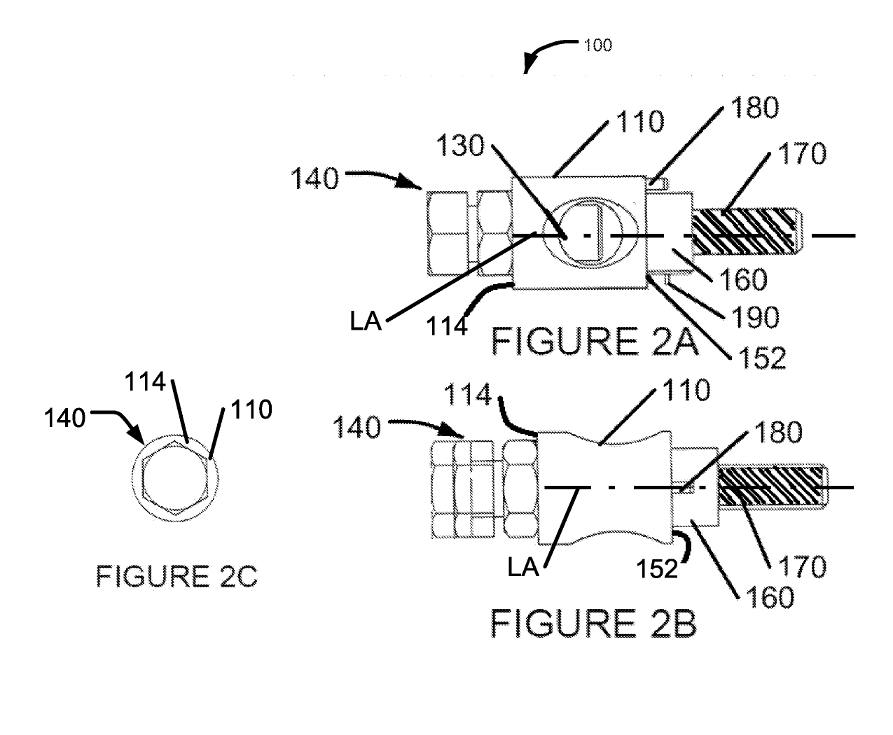

The connection point 130 can be defined in the body portion 110 transversely to the longitudinal axis LA. In some preferred embodiments, the connection point 130 can be defined in the body portion 110 perpendicularly to the longitudinal axis LA. The connection point 130 can be adapted to receive the electrical cable. The connection point 130 can be an opening defined in the body portion 110 transversely to the longitudinal axis LA, as best seen in FIGS. 1-2. The opening can be of any shape adapted to receive electrical cables of various sizes. In the illustrated embodiments shown in FIGS. 1-5D, the opening is circular with chamfered edges to allow for better contact and avoid sharp edges at the connection point 130.

In some embodiments, the connection point 130 can include grooves 132. When the electrical cable is inserted into the connection point and pressed by the electrical cable fastener 140, the grooves 132 can increase the surface area of contact between the electrical cable and the mechanical lug 100. The individual conductors of the electrical cable are brought into conformity with the surfaces of the grooves 132, resulting in greater surface area contact than if the connection point had a smooth connection surface. This increased surface contact can enhance the electrical connection between the electrical cable and the connection point 130. In some embodiments, the mechanical lug 100 can include indentations, flutes, projections, slots and the like for enhancing connection between the electrical cable and the connection point 130. Some such embodiments can be useful for providing better electrical connection because of higher surface area of contact between the electrical cable and the mechanical lug 100. Some such embodiments can make inadvertent disconnection of the electrical cable from the connection point 130—a potentially hazardous situation—significantly less likely. In some such embodiments, the grooves 132 can act as grippers, thereby increasing frictional force on the electrical cable and preventing it from slipping out of the connection point. Some such embodiments can make it less likely that individual conductors of the electrical cable are broken because of the load applied by the electrical cable fastener 140. The grooves 132 can distribute that load, lessening the chances of breaking any individual conductors. In many instances, the electrical cable's electrical conductivity can be significantly compromised if even a very low percentage (e.g., 1%) of the individual conductors are damaged or broken. In some embodiments, the grooves 132 can be threaded (right-hand or left-hand threads). In some embodiments, the grooves 132 can be a series of closed grooves rather than threads.

The electrical cable fastener 140 can be configured to press the electrical cable into contact with the grooves 132 once the electrical cable is inserted into the connection point 130. In the illustrated embodiment shown in FIGS. 1-3B, the electrical cable fastener 140 includes a hex-headed bolt 142 and cinch nut 141. In some embodiments, the electrical cable fastener 140 can include a threaded portion with external threads that can engage with the internal threads in the opening 112 of the body portion 110. In some such embodiments, the external threads on the electrical cable fastener 140 can be right-handed or left-handed threads to engage with internal threads of either left-handed or right-handed thread configuration. The electrical cable fastener 140 can be adapted to rotate when a torque is applied. The torque can be between approximately 300 inch-pounds and 400 inch-pounds. In the illustrated embodiment, as a torque of approximately 375 inch-pounds is applied on the hex-headed bolt assembly, the bolt 142 presses the electrical cable against the grooves 132 of the connection point 130. In some embodiments, the electrical cable fastener 140 can be mechanical fasteners such as screws, plug and grommet assemblies, clips, push-on connectors, and the like. Such mechanical fasteners can be adapted to hold the electrical cable into pressing contact with the grooves 132 at the connection point 130.

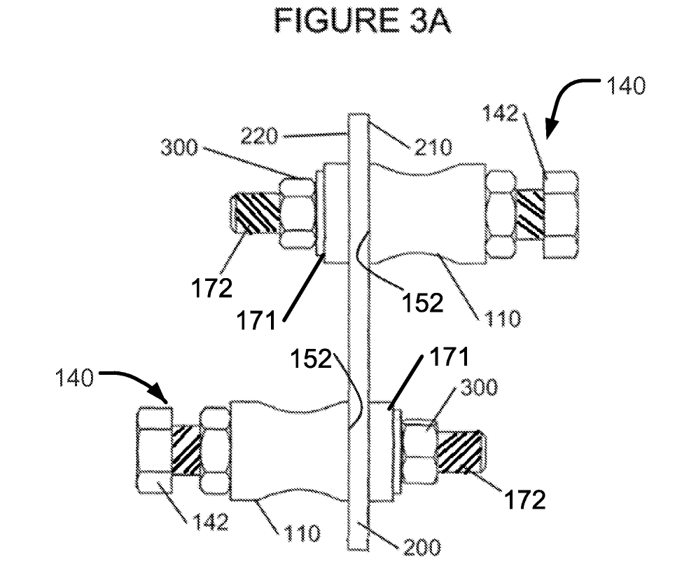

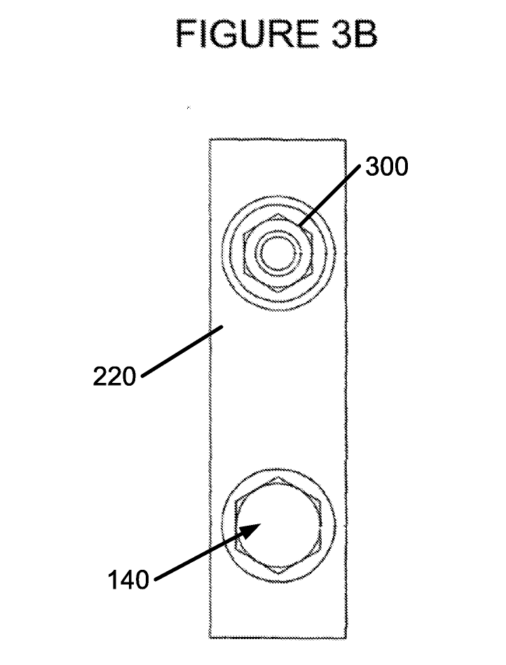

The shoulder portion 150 can be coupled to the body portion 110 and can press against the electrical device when engaged. In some embodiments, the shoulder portion 150 can be integrally formed with the body portion 110 by fabrication techniques such as casting or undercutting. The shoulder portion 150 can have a shoulder surface 152 that is oriented transversely to the longitudinal axis LA. As best seen in FIG. 3A-3B, in some embodiments, the shoulder surface 152 can be configured to contact a surface 210, 220 of the electrical device 200. Such embodiments can increase the surface area of contact between the mechanical lug 100 and the electrical device 200.

In some embodiments, the mechanical lug 100 can include a turn prevent 180. In some embodiments, the turn prevent 180 can extend from the shoulder portion 150 generally parallel to the longitudinal axis LA. As seen in FIGS. 2A-2B, the turn prevent 180 can be adapted to engage a receptacle in a surface of the electrical device to inhibit unwanted rotation of the mechanical lug 100 about the longitudinal axis LA. In some embodiments, the mechanical lug 100 can include a second turn prevent 190 extending from the shoulder portion 150 generally parallel to the longitudinal axis LA. The second turn prevent 190 can be adapted to engage a second receptacle in the first surface 210 of the electrical device 200 to further inhibit unwanted rotation of the mechanical lug 100 about the longitudinal axis LA. In some embodiments, the first and second turn prevents 180, 190 can each be generally cylindrical in shape. In some embodiments, the first and second receptacles can be of a shape (e.g., tear-drop, square or hexagonal in shape) to prevent rotation of the mechanical lug 100 about the longitudinal axis LA. In some embodiments, pins, clips, hooks, spacers and the like can be useful for inhibiting rotation of the mechanical lug 100 about the longitudinal axis LA. In some embodiments, the first and second turn prevents 180, 190 are cylindrical in shape and shown extending from the shoulder portion 150 such that the axis of the cylinder is parallel to the longitudinal axis LA of the mechanical lug 100. In some embodiments, the first and second turn prevents 180, 190 can extend from the shoulder portion 150 in any suitable direction (e.g. perpendicular to the longitudinal axis LA). In some embodiments (e.g., FIGS. 4A-4C), a turn prevent 190 can extend from the neck portion 160.

The first and second turn prevents 180, 190 when engaged with the first and second receptacles can inhibit inadvertently high torques on the mechanical lug 100 (e.g., torques exceeding 400 inch-pounds applied on the electrical cable fastener 140), thereby preventing damages to finely stranded electrical cable. Such embodiments can facilitate better mechanical connection between the mechanical lug 100 and the electrical device by preventing the electrical cable and the electrical device from being damaged during installation due to inadvertent application of high torques to the mechanical lug 100.

The neck portion 160 can be coupled to the shoulder portion 150 and can be configured to extend through a hole in the electrical device 200. The neck portion 160 can be integrally formed with the body portion 110 and the shoulder portion 150 by fabrication techniques such as casting, or metal forming (e.g., turning and undercutting). In some preferred embodiments, the neck portion 160 can include a neck surface 162 configured to contact a surface defining the hole in the electrical device 200. Such embodiments can be useful for increasing the surface area of contact between the mechanical lug 100 and the electrical device 200. In some embodiments, the entire (or nearly entire) surface of the neck portion 160 can contact the corresponding surface of the hole in the electrical device. In some embodiments, the neck surface 162 can be roughened to create a plurality of contact points between the neck surface 162 and the electrical device hole. Many such embodiments can offer a variety of advantages, such as enhanced electrical conductivity and better heat dissipation characteristics of the electrical connection. Such embodiments can allow the mechanical lug to be operable to very high temperatures, often on the order of 105 degrees Celsius.

Referring again to FIG. 3A, in some embodiments, the electrical device fastener 170 can be configured to fasten the mechanical lug 100 to the electrical device. In some embodiments, the electrical device fastener 170 includes a threaded portion 172 threadingly connectable with a threaded fastener 300. The threaded fastener 300 can be a bolt and nut assembly. In some embodiments, threaded fastener 300 can be in contact with a surface 210, 220 of the electrical device 200 opposite the surface 210, 220 that is contacted by the shoulder surface 152 when fully fastened with the threaded portion of the electrical device fastener 170. The surfaces 210, 220 of the electrical device 200 can be disposed at a distance along the longitudinal axis LA from one another. In some embodiments, the first and second surfaces 210, 220 of the electrical device 200 can be planar surfaces of the electrical device (e.g., bus bar). In such embodiments, the first and second surfaces 210, 220 can be separated by a thickness of the bus bar “T”. The hole in the bus bar can be adapted to receive the threaded portion 172 of the electrical device fastener 170. A bolt and nut assembly, along with a washer assembly 171, can be threadingly engaged with the threaded portion 172 of the electrical device fastener 170, thereby mechanically coupling the mechanical lug 100 to the bus bar. A predetermined torque can be applied to the bolt and nut assembly to secure the mechanical lug 100 to the electrical device 200. The predetermined torque can allow the bolt and nut assembly to contact the electrical device 200. Such embodiments can facilitate a rugged mechanical connection between the mechanical lug 100 and the electrical device and ensure good electrical contact between the electrical cable. As noted, turn prevents 180, 190 can inhibit unwanted rotation of the mechanical lug 100 about the longitudinal axis LA.

Embodiments of the mechanical lug 100 can have a variety of material properties. In some embodiments, the mechanical lug 100 can have an electrical conductivity of at least 80% IACS. In some embodiments, the mechanical lug 100 can have an electrical conductivity of at least 85% IACS. In many instances, an electrical conductivity in the range of approximately 80% to approximately 85% can enhance the electrical contact between the electrical cable and the electrical device. In some embodiments, the mechanical lug 100 can have a material hardness of at least B70. In some embodiments, the mechanical lug 100 can have a material hardness of at least B83. In many instances, a material hardness in the range of B70-B83 can facilitate a durable and mechanically rugged construction of the mechanical lug 100, ensuring that the mechanical lug 100 does not deform over time. In some preferred embodiments, the mechanical lug 100 can have an electrical conductivity of at least 80% IACS and a material hardness of at least B70. In some preferred embodiments, the mechanical lug 100 can have an electrical conductivity of at least 80% IACS and a material hardness of at least B83. In some preferred embodiments, the mechanical lug 100 can have an electrical conductivity of at least 85% IACS and a material hardness of at least B70. In some preferred embodiments, the mechanical lug 100 can have an electrical conductivity of at least 85% IACS and a material hardness of at least B83.

Embodiments of the mechanical lug can be made of a variety of alloys. In some embodiments, the mechanical lug 100 can be made of 18150 class 2 copper zirconium. In some embodiments, the mechanical lug 100 can be made of an alloy comprising between approximately 98.25% and approximately 99.45% copper, between approximately 0.5% and approximately 1.5% chromium and between approximately 0.05% and approximately 0.25% zirconium. Some such embodiments can be useful for superior electrical conductivity and material durability, because of the combination of high electrical conductivity of copper relative to other metals (e.g. nickel, steel, and the like) and the high material hardness of the alloy that includes chromium and zirconium in comparison to pure copper. An alloy of composition similar to those listed can be used for fabricating the mechanical lug 100 without loss of functionality.

Embodiments of the invention can include a method for connecting a cable to an electrical device. The method may include providing a mechanical lug (e.g., like those discussed elsewhere herein). In some embodiments, the method can include uncovering (e.g., stripping) a portion of an electrical cable. The method can include inserting an uncovered portion of the electrical cable into a connection point of the mechanical lug and pressing the uncovered portion of the electrical cable into contact with the grooves by the electrical cable fastener. In some embodiments, the method can include extending the neck portion of the mechanical lug through a hole in the electrical device and bringing the shoulder portion into contact with a first surface of the electrical device. In some instances, the method can include fastening the mechanical lug to the electrical device with the electrical device fastener. The mechanical lug such as those described herein can be useful for connecting an electrical cable with an electrical device, such as a bus bar or a power distribution panel in household power supply lines or industrial power transmission facilities.

Some embodiments can include various safety features for preventing tampering with the mechanical lug when connected to an electrical cable and an electrical device. For example, some embodiments can include outside insulation over the mechanical lug, electrical cable, and electrical device. Some embodiments may provide a tamper-resistant enclosure. In some embodiments, when the mechanical lug is connected to an electrical cable and an electrical device, the assembly can be considered finger safe.

Various examples of the invention have been described. Although the present invention has been described in considerable detail with reference to certain disclosed embodiments, the embodiments are presented for purposes of illustration and not limitation. Other embodiments incorporating the invention are possible. One skilled in the art will appreciate that various changes, adaptations, and modifications may be made without departing from the spirit of the invention and the scope of the appended claims.

1. A mechanical lug for electrically connecting an electrical cable and an electrical device, the mechanical lug comprising:
(a) a body portion having a longitudinal axis;
(b) a connection point defined in the body portion transversely to the longitudinal axis, the connection point comprising grooves;
(c) an electrical cable fastener configured to press the electrical cable into contact with the grooves when the electrical cable is inserted into the connection point;
(d) a shoulder portion coupled to the body portion and having a shoulder surface that is oriented transversely to the longitudinal axis and that is configured to contact a first surface of the electrical device;
(e) a neck portion coupled to the shoulder portion and being configured to extend through a hole in the electrical device; and
(f) an electrical device fastener configured to fasten the mechanical lug to the electrical device.

2. The mechanical lug of claim 1, wherein the neck portion includes a neck surface configured to contact a surface defining the hole in the electrical device.

3. The mechanical lug of claim 1, wherein the mechanical lug has an electrical conductivity of at least 80% IACS and material hardness of at least B70.

4. The mechanical lug of claim 1, wherein the mechanical lug has an electrical conductivity of at least 85% IACS and material hardness of at least B83.

5. The mechanical lug of claim 1, wherein the mechanical lug has an electrical conductivity of at least 85% IACS and material hardness of at least B70.

6. The mechanical lug of claim 1, wherein the mechanical lug has an electrical conductivity of at least 80% IACS and material hardness of at least B83.

7. The mechanical lug of claim 1, wherein the mechanical lug is made of an alloy comprising between approximately 98.25% and approximately 99.45% copper, between approximately 0.5% and approximately 1.5% chromium and between approximately 0.05% and approximately 0.25% zirconium.

8. The mechanical lug of claim 1, further comprising a first turn prevent extending from the shoulder portion generally parallel to the longitudinal axis, the first turn prevent adapted to engage a first receptacle in the first surface of the electrical device to inhibit rotation of the mechanical lug about the longitudinal axis.

9. The mechanical lug of claim 8, further comprising a second turn prevent extending from the shoulder portion generally parallel to the longitudinal axis, the second turn prevent adapted to engage a second receptacle in the first surface of the electrical device to further inhibit rotation of the mechanical lug about the longitudinal axis.

10. The mechanical lug of claim 9, wherein the first and second turn prevents are each generally cylindrical in shape.

11. The mechanical lug of claim 1, wherein the connection point is defined in the body portion perpendicularly to the longitudinal axis.

12. The mechanical lug of claim 1, wherein the electrical device fastener includes a threaded portion threadingly connectable with a threaded fastener.

13. The mechanical lug of claim 12, wherein the threaded fastener is in contact with a second surface of the electrical device when fully fastened with the threaded portion of the electrical device fastener, the second surface disposed at a distance along the longitudinal axis from the first surface.

14. A method comprising:
(a) providing a mechanical lug that includes:
(i) a body portion having a longitudinal axis,
(ii) a connection point defined in the body portion transversely to the longitudinal axis, the connection point comprising grooves,
(iii) an electrical cable fastener,
(iv) a shoulder portion coupled to the body portion and having a shoulder surface that is oriented transversely to the longitudinal axis,
(v) a neck portion coupled to the shoulder portion, and
(vi) an electrical device fastener;
(b) inserting an uncovered portion of an electrical cable into the connection point;
(c) pressing the uncovered portion of the electrical cable into contact with the grooves by the electrical cable fastener;
(d) extending the neck portion through a hole in an electrical device;
(e) bringing the shoulder portion into contact with a first surface of the electrical device; and
(f) fastening the mechanical lug to the electrical device with the electrical device fastener.

15. The method of claim 14, wherein extending the neck portion through a hole in the electrical device comprises bringing a neck surface of the neck portion into contact with a surface defining the hole in the electrical device.

16. The method of claim 14, wherein the mechanical lug has an electrical conductivity of at least 80% IACS and material hardness of at least B70.

17. The method of claim 14, wherein the mechanical lug has an electrical conductivity of at least 85% IACS and material hardness of at least B83.

18. The method of claim 14, wherein the mechanical lug has an electrical conductivity of at least 85% IACS and material hardness of at least B70.

19. The method of claim 14, wherein the mechanical lug has an electrical conductivity of at least 80% IACS and material hardness of at least B83.

20. The method of claim 14, wherein the mechanical lug is made of an alloy comprising between approximately 98.25% and approximately 99.45% copper, between approximately 0.5% and approximately 1.5% chromium and between approximately 0.05% and approximately 0.25% zirconium.

21. The method of claim 14, wherein the mechanical lug includes a first turn prevent extending from the shoulder portion generally parallel to the longitudinal axis, and wherein the method further comprises (g) engaging a first receptacle in the first surface of the electrical device with the first turn prevent before fastening the mechanical lug to the electrical device to inhibit rotation of the mechanical lug about the longitudinal axis.

22. The method of claim 21, wherein the mechanical lug includes a second turn prevent extending from the shoulder portion generally parallel to the longitudinal axis, and wherein the method further comprises (h) engaging a second receptacle in the first surface of the electrical device with the second turn prevent before fastening the mechanical lug to the electrical device to further inhibit rotation of the mechanical lug about the longitudinal axis.

23. The method of claim 22, wherein the first and second turn prevents are each generally cylindrical in shape.

24. The method of claim 14, wherein the connection point is defined in the body portion perpendicularly to the longitudinal axis.

25. The method of claim 14, wherein the electrical device fastener includes a threaded portion, and wherein fastening the mechanical lug to the electrical device comprises connecting a threaded fastener to the threaded portion.

26. The method of claim 25, wherein connecting the threaded fastener to the threaded portion comprises bringing the threaded fastener into contact with a second surface of the electrical device, the second surface disposed at a distance along the longitudinal axis from the first surface.

27. A mechanical lug for electrically connecting an electrical cable and an electrical device, the mechanical lug comprising:
(a) a body portion having a longitudinal axis;
(b) a connection point defined in the body portion transversely to the longitudinal axis, the connection point comprising connection means for enhancing connection between the electrical cable and the connection point;
(c) an electrical cable fastener configured to press the electrical cable into contact with the connection means when the electrical cable is inserted into the connection point;
(d) a shoulder portion coupled to the body portion and having a shoulder surface that is oriented transversely to the longitudinal axis and that is configured to contact a first surface of the electrical device;
(e) a neck portion coupled to the shoulder portion and being configured to extend through a hole in the electrical device; and
(f) an electrical device fastener configured to fasten the mechanical lug to the electrical device.

28. The mechanical lug of claim 27, wherein the neck portion includes a neck surface configured to contact a surface defining the hole in the electrical device.

29. The mechanical lug of claim 27, wherein the mechanical lug has an electrical conductivity of at least 80% IACS and material hardness of at least B70.

30. The mechanical lug of claim 27, wherein the mechanical lug has an electrical conductivity of at least 85% IACS and material hardness of at least B83.

31. The mechanical lug of claim 27, wherein the mechanical lug has an electrical conductivity of at least 85% IACS and material hardness of at least B70.

32. The mechanical lug of claim 27, wherein the mechanical lug has an electrical conductivity of at least 80% IACS and material hardness of at least B83.

33. The mechanical lug of claim 27, wherein the mechanical lug is made of an alloy comprising between approximately 98.25% and approximately 99.45% copper, between approximately 0.5% and approximately 1.5% chromium and between approximately 0.05% and approximately 0.25% zirconium.

34. The mechanical lug of claim 27, further comprising turn prevention means for inhibiting rotation of the mechanical lug about the longitudinal axis.

35. The mechanical lug of claim 27, wherein the connection point is defined in the body portion perpendicularly to the longitudinal axis.

36. The mechanical lug of claim 27, wherein the electrical device fastener includes a threaded portion threadingly connectable with a threaded fastener.

37. The mechanical lug of claim 36, wherein the threaded fastener is in contact with a second surface of the electrical device when fully fastened with the threaded portion of the electrical device fastener, the second surface disposed at a distance along the longitudinal axis from the first surface.
